(19) United States
(12) Patent Application Publication
(10) Pub. No.: US 2015/0093042 A1
(43) Pub. Date: Apr. 2, 2015

(54) PARAMETER CALIBRATION METHOD AND APPARATUS

(71) Applicant: Huawei Technologies Co., Ltd., Shenzhen (CN)

(72) Inventors: Yunfang ZHU, Hangzhou (CN); Shuiping LI, Shenzhen (CN); Xin DU, Hangzhou (CN)

(21) Appl. No.: 14/563,287

(22) Filed: Dec. 8, 2014

Related U.S. Application Data
(63) Continuation of application No. PCT/CN2013/076972, filed on Jun. 8, 2013.

(30) Foreign Application Priority Data
Jun. 8, 2012 (CN) 201210188585.5

(51) Int. Cl. G06T 7/00; G06T 5/00

(52) U.S. Cl. CPC G06T 7/0018; G06T 5/006; G06T 2207/10004; G06T 2207/10016
USPC 382/275

(57) ABSTRACT

Embodiments of the present invention disclose a parameter calibration method. The method includes: acquiring a calibration template image, where the calibration template image is obtained by photographing a calibration template; performing corner detection on the calibration template image to extract image corners; calculating a radial distortion parameter according to the extracted image corners; performing radial distortion correction according to the calculated radial distortion parameter, so as to reconstruct a distortion correction image; and according to a perspective projection relationship between the calibration template and the reconstructed distortion correction image, calculating intrinsic and extrinsic parameters to implement parameter calibration, where the intrinsic and extrinsic parameters include: a matrix of intrinsic parameters, a rotational vector, and a translational vector. The present invention may be applied to parameter calibration for an imaging apparatus such as a camcorder and a camera in a case of a high distortion.

### CROSS-REFERENCE TO RELATED APPLICATIONS

This application is a continuation of International Patent Application No. PCT/CN2013/076972, filed on Jun. 8, 2013, which claims priority to Chinese Patent Application No. 201210188585.5, filed on Jun. 8, 2012, both of which are hereby incorporated by reference in their entireties.

### TECHNICAL FIELD

The present invention relates to the fields of computer vision and image measurement, and in particular, to a camcorder calibration method and apparatus.

### BACKGROUND

In an image measurement process and a computer vision application, in order to determine a relationship between a three-dimensional geometric location of a certain point on a surface of a spatial object and a corresponding point thereof in an image, a geometric model for imaging must be established. Parameters of the geometric model are parameters of a photography apparatus, such as a camcorder and a camera. Under most conditions, these parameters can be obtained only by performing experiments and computations; and a process of solving for the parameters is referred to as camcorder calibration (or camera calibration). Camcorder calibration is used as an example. Existing camcorder calibration methods are generally classified into two types: traditional object-based calibration methods and image sequence-based self-calibration methods.

Among the traditional calibration methods, a two-step method and a planar template calibration method are typical. The two-step method is to divide calibration work into two steps: First, determine a perspective projection matrix; and then restore intrinsic and extrinsic parameters of a camcorder from the perspective projection matrix. Because a high precision three-dimensional calibration block needs to be made in this method, it is inconvenient to implement the method. In the planar template calibration method, according to a characteristic that two equations for intrinsic parameters of a camcorder can be established based on calibration points on a same plane, the intrinsic parameters are solved for by using multiple planes of different locations and directions, and then extrinsic parameters of the camcorder are calculated. Because it is required to photograph only several planar templates at different angles or locations in the planar template calibration method, an operation is relatively simple. Therefore, this method is widely used in practice.

Different from the traditional calibration methods, the self-calibration methods do not require a given calibration object but use geometric knowledge of a scene or a constraint relationship of specific camcorder motion to perform calibration on intrinsic and extrinsic parameters of a camcorder. Constraints of intrinsic parameters of a camcorder are mainly used in these types of methods to restore parameters of the camcorder by using a method such as solving of Kruppa equations or hierarchical step-wise calibration, where the constraints are unrelated to a scene and motion of the camcorder. However, because the self-calibration methods are less precise than the traditional calibration methods, the self-calibration methods are applied only to a given scenario.

On the other hand, distortion modeling and calibration of a camcorder are also extremely important content. In fact, a lens distortion may more or less exist on a camcorder. There are multiple types of distortions on a camcorder, and among those types of distortions, a radial distortion is a main type. For distortion calibration, a classical method (such as a planar template method) is to first assume that a camcorder uses a pinhole camera model, obtain intrinsic parameters of the camcorder by performing calibration, and then solve for a polynomial distortion model parameter by using a non-linear optimization method. This method is feasible when a distortion of a camcorder is not severe; however, this method fails when it is applied to a case of a high distortion, such as a fish-eye lens.

It can be learnt that in the prior art, the traditional calibration methods fail in a case of a high distortion, and the self-calibration methods are less precise than the traditional methods; therefore, how to implement a camcorder (or a camera) calibration method that is simple to operate, capable of processing a highly distorted image, and has relatively high precision is an urgent problem to be solved.

### SUMMARY

Embodiments of the present invention provide a parameter calibration method and apparatus, which can be applied to parameter calibration for an imaging apparatus such as a camcorder (or a camera) in a case of a high distortion, and are simple to operate and are of high precision.

According to a first aspect, an embodiment of the present invention provides a parameter calibration method, including:

acquiring a calibration template image, where the calibration template image is obtained by photographing a calibration template;

performing corner detection on the calibration template image to extract image corners;

calculating a radial distortion parameter according to the extracted image corners;

performing radial distortion correction according to the calculated radial distortion parameter, so as to reconstruct a distortion correction image; and

according to a perspective projection relationship between the calibration template and the reconstructed distortion correction image, calculating intrinsic and extrinsic parameters to implement parameter calibration, where the intrinsic and extrinsic parameters include: a matrix of intrinsic parameters, a rotational vector, and a translational vector.

Based on a feature of the first aspect, the present invention further provides a parameter calibration method, where the method further includes:

optimizing the calculated intrinsic and extrinsic parameters by using a criterion of a minimum re-projection error and by means of the Levenberg-Marquardt algorithm.

According to a second aspect, an embodiment of the present invention provides a parameter calibration apparatus, where the apparatus includes:

an acquiring unit, configured to acquire a calibration template image, where the calibration template image is obtained by photographing a calibration template;

a detecting unit, configured to perform corner detection on the calibration template image to extract image corners;

a calculating unit, configured to calculate a radial distortion parameter according to the extracted image corners;

a correcting unit, configured to perform radial distortion correction according to the calculated radial distortion parameter, so as to reconstruct a distortion correction image; and

a calibration unit, configured to, according to a perspective projection relationship between the calibration template and the reconstructed distortion correction image, calculate intrinsic and extrinsic parameters to implement parameter calibration, where the intrinsic and extrinsic parameters include: a matrix of intrinsic parameters, a rotational vector, and a translational vector.

With reference to a feature of the second aspect, the present invention further provides a parameter calibration apparatus, where the apparatus further includes:

an optimizing unit, configured to optimize the calculated intrinsic and extrinsic parameters by using a criterion of a minimum re-projection error and by means of the Levenberg-Marquardt algorithm.

In the method provided in the embodiments of the present invention, in order to process a highly distorted image, a calibration template image is first photographed; a radial distortion parameter is estimated by using a constraint that a straight line in a planar calibration template is projected as a circular arc in a calibration template image under a single parameter division model; distortion correction is performed, so that the calibration template image conforms to perspective projection imaging; a homography matrix between a reconstructed distortion correction image and the planar calibration template is calculated; on an assumption that a principal point is a distortion center and an obliquity factor is zero, an ideal focal length is estimated; and the foregoing result is used as an initial value to perform non-linear optimization, so as to obtain a precise calibration result. This method is simple to operate and provides high precision.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic flowchart of a parameter calibration method according to Embodiment 1 of the present invention;

FIG. 2 is a schematic plan view of a calibration template according to Embodiment 1 of the present invention;

FIG. 3 is a schematic diagram of polar coordinate transformation of a distortion point (x_{di}, y_{di}) in a calibration template image and a correction point (xᵤᵢ, yᵤᵢ) in a distortion correction image according to Embodiment 1 of the present invention; and

FIG. 4 is a schematic diagram of a parameter calibration apparatus according to Embodiment 2 of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

### Embodiment 1

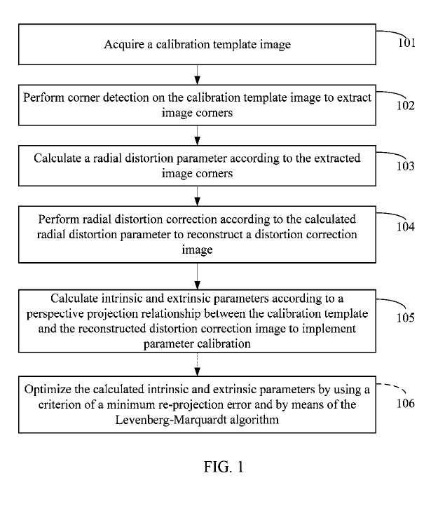

As shown in FIG. 1, Embodiment 1 of the present invention provides a parameter calibration method, and the method includes the following steps:

101. Acquire a calibration template image, where the calibration template image is obtained by photographing a calibration template.

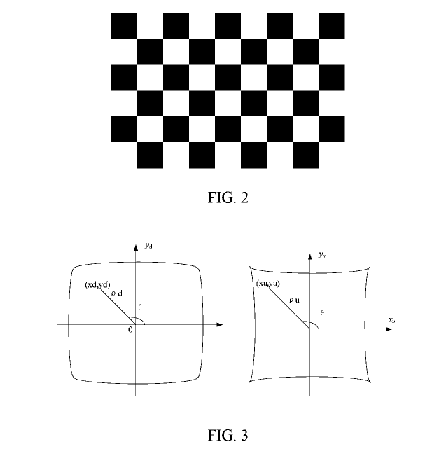

In step 101, the calibration template adopted in this embodiment may be a calibration template with an array of fixed spacing patterns, specifically including a checkerboard calibration template, a calibration template with an equal spacing solid-circular array, and the like. Preferably, in this embodiment, a checkerboard calibration template generally used in a camcorder (or a camera) calibration method may be adopted, specifically as shown in FIG. 2.

It should be noted that in order to perform radial distortion correction and parameter calibration for a camcorder (or a camera), it is required to photograph a calibration template, so as to obtain a calibration template image. In specific implementation, a distribution condition that is of grid point coordinates of a calibration template and is on a plane is established according to the number of grid points of the calibration template in horizontal and vertical directions and a size of each grid point.

102. Perform corner detection on the calibration template image to extract image corners.

In step 102, because a distortion generally exists in an image actually photographed by using a lens of a camcorder (or a camera), compared with an actual calibration template, the calibration template image is an image with a distortion. Therefore, the image corners extracted by performing corner detection are image corners with a distortion.

A person skilled in the art should understand that a corner is an important feature of an image, which plays an important role in understanding and analysis of an image and a graph. There is no explicit mathematic definition for a corner; it is generally considered that a corner is a point with dramatically varying brightness in a two-dimensional image or a point that has a maximum curvature on an edge curve in an image. A corner effectively reduces a data volume of information while maintaining important features of an image or a graph, thereby causing a large content of information of the image or graph, effectively increasing a computation speed, facilitating reliable matching of images, and making real-time processing possible. A corner also plays an extremely important role in the field of computer vision, such as three-dimensional scene reconstruction, motion estimation, target tracing, target identification, and image registration and matching. Currently, a corner detection algorithm includes grayscale image-based corner detection, binary image-based corner detection, profile curve-based corner detection, and the like.

103. Calculate a radial distortion parameter according to the extracted image corners.

It should be noted that in computer vision, an image is a reflection of a spatial object in an image plane by using an imaging system, that is, a projection of the spatial object onto the image plane. A grayscale of each pixel point in an image represents intensity of reflected light at a certain point on the surface of a spatial object, and a location of the pixel point in the image is related to a geometrical location of a corresponding point on the surface of the spatial object. A relationship between these locations depends on a geometrical projection model of a camcorder (or a camera) system, where a projection relationship of an object from three-dimensional space to an image plane is an imaging model. An ideal projection imaging model is central projection in optics, also referred to as a pinhole model. Under an ideal perspective projection model, a straight line in the calibration template should be also a straight line in the calibration template image. However, because a distortion exists in an actual image, under a single parameter division model, a straight line in the calibration template is presented as a circular arc in the calibration template image.

In step 103, the calculating a radial distortion parameter according to the extracted image corners may specifically include:

103a. Based on the single parameter division model, model a radial distortion of a camcorder (or a camera), so as to establish a coordinate transformation relationship between the calibration template image and the distortion correction image obtained by correcting the calibration template image, where specific modeling is shown in formula (1):

$${x}_{u} = \frac{{x}_{d}}{1 + λ {r}_{d}^{2}} \qquad ( 1 )$$

In formula (1), x_{d}=(x_{d},y_{d}) is a coordinate of any distortion point in the calibration template image, xᵤ=(xᵤ,yᵤ) is a coordinate of a correction point that is in the distortion correction image and obtained after x_{d}=(x_{d},y_{d}) is corrected, λ is a radial distortion parameter, and r_{d}²=x_{d}²+y_{d}².

103b. According to a correspondence that a straight line in the calibration template is presented as a circular arc in the calibration template image due to an imaging distortion, perform fitting in combination with the image corners to obtain circular arc parameters of the circular arc.

Specifically, assuming herein that a non-distortion straight line equation for a straight line in the calibration template and after an ideal perspective projection is performed on the straight line is:

axᵤ+byᵤ+c=0 (2)

In formula (2), {a,b,c} are parameters of a straight line.

In an actual image, due to existence of the distortion, under the single parameter division model, the straight line is presented as a circular arc in the calibration template image, and formula (1) is substituted into the straight line equation (2) to obtain:

$${x}_{d}^{2} + {y}_{d}^{2} + \frac{a}{c λ} {x}_{d} + \frac{b}{c λ} {y}_{d} + \frac{1}{λ} = 0 \qquad ( 3 )$$

It can be learnt from formula (3) that the circular arc already includes information about the radial distortion parameter. If the circular arcs are found, the radial distortion parameter may be estimated by using the circular arc parameters.

Herein, formula (3) is modified as a general form of a circular arc:

x_{d}²+y_{d}²+Aᵢx_{d}+Bᵢy_{d}+Cᵢ=0 (4)

In formula (4), {Aᵢ,Bᵢ,Cᵢ|i=1, 2, 3} are circular arc parameters, where

$${A}_{i} = \frac{a}{c λ} , \\ {B}_{i} = \frac{b}{c λ} , \\ and$$

$${C}_{i} = \frac{1}{λ} .$$

For each pixel point belonging to the circular arc, an equation may be obtained. Therefore, to solve for the circular arc parameters in formula (4), at least three pixel points are required to establish an equation set. Because the number of image corners actually extracted is generally greater than 3, the circular arc parameters in a sense of least-square can be obtained by substituting these image corners into formula (4).

103c. Calculate the radial distortion parameter according to the circular arc parameters obtained by means of fitting.

Specifically, when there exist three circular arcs, according to the circular arc parameters {Aᵢ,Bᵢ,Cᵢ|i=1, 2, 3} obtained by means of fitting, both the radial distortion parameter λ and a distortion center (x_{d0},y_{d0}) may be calculated according to formula (5):

(A₁−A₂)x_{d0}+(B₁−B₂)y_{d0}+(C₁−C₂)=0

(A₁−A₃)x_{d0}+(B₁−B₃)y_{d0}+(C₁−C₃)=0

(A₂−A₃)x_{d0}+(B₂−B₃)y_{d0}+(C₂−C₃)=0 (5)

In the formula above, {Aᵢ,Bᵢ,Cᵢ|i=1, 2, 3} are three circular arc parameters.

After the distortion center (x_{d0},y_{d0}) is solved for, the radial distortion parameter λ may be obtained by using formula (6):

$$\frac{1}{λ} = {x}_{d 0}^{2} + {y}_{d 0}^{2} + {A}_{i} {x}_{d 0} + {B}_{i} {y}_{d 0} + {C}_{i} \qquad ( 6 )$$

In formula (6), Aᵢ, Bᵢ, Cᵢ is any one of the three circular arcs.

When the number of circular arcs is greater than 3, a solution to the radial distortion parameter λ in the sense of least-square may be calculated.

104. Perform radial distortion correction according to the calculated radial distortion parameter, so as to reconstruct a distortion correction image.

Specifically, radial distortion correction is performed according to the solved radial distortion parameter λ; and

according to formula (1),

$${x}_{u} = \frac{{x}_{d}}{1 + λ {r}_{d}^{2}} \\ and \\ {y}_{u} = \frac{{y}_{d}}{1 + λ {r}_{d}^{2}} \qquad ( 7 )$$

are obtained.

Formula (7) shows a formula in which a coordinate (x_{d},y_{d}) in a calibration template image is directly projected as a coordinate (xᵤ,yᵤ) in a distortion correction image after correction.

It should be noted that under such projection, for reasons of integer sampling, there may be many unknown information points in a distortion correction image. A relatively proper radial distortion correction method is to solve for, in the calibration template image according to the radial distortion parameter and according to an inverse process that the calibration template image is derived from the distortion correction image, a coordinate of a distortion point (x_{di},y_{di}) corresponding to a correction point (xᵤᵢ,yᵤᵢ) in the distortion correction image. Bilinear interpolation is performed on the solved coordinate of the distortion point (x_{di},y_{di}) in the calibration template image, so as to obtain a coordinate of a correction point (xᵤᵢ′,yᵤᵢ′) after radial distortion correction, and so as to implement the reconstruction of the distortion correction image. Herein, a subscript i is a number used for differentiating between different points in a same coordinate system.

Specifically, in an embodiment of the present invention, the radial distortion correction may be performed by using the following method, and specific steps are as follows:

1) Move an original point of the calibration template image to the distortion center (x_{d0},y_{d0}), so as to obtain:

r_{d}²=x_{d}²+y_{d}².

2) For each correction point (xᵤᵢ,yᵤᵢ) after distortion correction, obtain:

$$\frac{{y}_{ui}}{{x}_{ui}} = \frac{\frac{{y}_{di}}{1 + λ {r}_{di}^{2}}}{\frac{{x}_{di}}{1 + λ {r}_{di}^{2}}} = \frac{{y}_{di}}{{x}_{di}} = {k}_{i} \qquad ( 8 )$$

In formula (8), kᵢ indicates that the distortion center (x_{d0},y_{d0}), the distortion point (x_{di},y_{di}), and the correction point (xᵤᵢ,yᵤᵢ) corresponding to the distortion point are collinear.

3) In combination with 1) and 2), establish the following equation set:

$$\{ \begin{matrix}{y}_{di} = \frac{{y}_{ui}}{{x}_{ui}} {x}_{di} = {k}_{i} {x}_{di} \\ {x}_{ui} = \frac{{x}_{di}}{1 + λ ( {x}_{di}^{2} + {y}_{di}^{2} )}\end{matrix} \qquad ( 9 )$$

Solve the equation set to obtain:

$${x}_{di} = \frac{1 \pm \sqrt{1 - 4 \cdot λ {x}_{ui} ( 1 + {k}_{i}^{2} ) \cdot {x}_{ui}}}{2 λ {x}_{ui} ( 1 + {k}_{i}^{2} )} \qquad ( 10 )$$

Because λ<0, formula (10) inevitably has two real number solutions; however, in the two solutions, because xᵤᵢ and x_{di} must be either positive or negative, a valid solution x_{di} can still be uniquely determined. After x_{di} is solved for, x_{di} is substituted into the first equation of equation set (9) to solve for y_{di}.

4) After the distortion point (x_{di},y_{di}) is solved for, a pixel value of a point (xᵤᵢ′,yᵤᵢ′), after distortion correction is obtained by performing bilinear interpolation.

In another embodiment of the present invention, a distortion point (x_{di},y_{di}) and a correction point (xᵤᵢ, yᵤᵢ) may further be transformed into polar coordinates for expression. Solving is performed with the polar coordinates, as shown in FIG. 3, which is specifically as follows:

Assuming that a distortion point (ρ_{d},θ_{d}) corresponds to a correction point (ρᵤ,θᵤ) after correction, θᵤ=θ_{d}, and therefore it is required to determine only ρ_{d}.

According to formula (7),

$${ρ}_{u}^{2} = {x}_{u}^{2} + {y}_{u}^{2} = \frac{{ρ}_{d}^{2}}{( 1 + λ {ρ}_{d}^{2} )} \qquad ( 11 )$$

is obtained.

Then a quadratic equation of one unknown for ρ_{d}² may be established, and by applying ρ_{d}>0 and a constraint of ρ_{d}<ρᵤ, a unique solution to ρ_{d} may be solved for.

105. Calculate intrinsic and extrinsic parameters according to a perspective projection relationship between the calibration template and the reconstructed distortion correction image to implement parameter calibration, where

the intrinsic and extrinsic parameters include a matrix of intrinsic parameters, a rotational vector, and a translational vector.

According to the perspective projection relationship between the calibration template and the reconstructed distortion correction image, a homography matrix (Homography) H may be estimated:

s\tilde{x}ᵤ=H\tilde{M} (12)

In formula (12), s is a scale factor, \tilde{M} is a homogeneous coordinate of a point in the calibration template, and \tilde{x}ᵤ is a homogeneous coordinate of a point obtained after \tilde{M} is projected onto the reconstructed distortion correction image, where

H=K[r₁r₂t] (13)

where

$$k = [ \begin{matrix}{f}_{a} & c & {u}_{0} \\ 0 & {f}_{b} & {v}_{0} \\ 0 & 0 & 1\end{matrix} ]$$

is a matrix of intrinsic parameters of a camcorder (or a camera), r₁ and r₂ are rotational vectors and r₁ and r₂ are orthogonal, t is a translational vector, (u₀,v₀) is a principal point of the matrix of intrinsic parameters, c is an obliquity factor, and (fₐ,f_{b}) is an ideal focal length of a lens of the camcorder (or the camera).

Due to orthogonality of r₁ and r₂,

$$\{ \begin{matrix}{h}_{1}^{T} {K}^{- T} {K}^{- 1} {h}_{2} = 0 \\ {h}_{1}^{T} {K}^{- T} {K}^{- 1} {h}_{1} = {h}_{2}^{T} {K}^{- T} {K}^{- 1} {h}_{2}\end{matrix} \qquad ( 14 )$$

In formula (14), h₁ and h₂ are forms of expressing column vectors of the matrix H, and H=[h₁ h₂ h₃]. Formula (14) shows two basic constraint equations that solve for the matrix of intrinsic parameters.

Because only one calibration template image is adopted in the present invention, it is impossible to solve for all of 5 unknown numbers in the matrix K of intrinsic parameters. Therefore, several parameters in the matrix of intrinsic parameters are predefined:

a) It is preset that an initial value of the principal point (u₀,v₀) coincides with the distortion center (x_{d0},y_{d0}). Even though it is proven by many researchers that a principal point does not coincide with a distortion center, it is noted that the principal point is generally extremely close to the distortion center. Therefore, it is proper to assume that the distortion center is the initial value of the principal point. A precise coordinate of the principal point is to be obtained by subsequent non-linear optimization.

b) It is preset that the obliquity factor c=0; and for most lenses, this is a proper assumption.

Therefore, a solution to a matrix of intrinsic parameters of a camcorder (or a camera) is simplified to a solution to two unknown numbers fₐ and f_{b}. Because of

$${K}^{- T} {K}^{- 1} = [ \begin{matrix}\frac{1}{{f}_{a}^{2}} & 0 & - \frac{{u}_{0}}{{f}_{a}^{2}} \\ 0 & \frac{1}{{f}_{b}^{2}} & - \frac{{v}_{0}}{{f}_{b}^{2}} \\ - \frac{{u}_{0}}{{f}_{a}^{2}} & - \frac{{v}_{0}}{{f}_{b}^{2}} & \frac{{u}_{0}^{2}}{{f}_{a}^{2}} + \frac{{v}_{0}^{2}}{{f}_{b}^{2}} + 1\end{matrix} ] ,$$

the constraint of formula (14) is applied to obtain:

$$[ \begin{matrix}{m}_{11} & {m}_{12} \\ {m}_{21} & {m}_{22}\end{matrix} ] \cdot [ \begin{matrix}\frac{1}{{f}_{a}^{2}} \\ \frac{1}{{f}_{b}^{2}}\end{matrix} ] = [ \begin{matrix}- {h}_{13} {h}_{23} \\ {h}_{23}^{2} - {h}_{13}^{2}\end{matrix} ] \qquad ( 15 )$$

In formula (15):

m₁₁=h₁₁h₂₁−u₀(h₁₃h₂₁+h₁₁h₂₃)+u₀²(h₁₃h₂₃)

m₁₂=h₁₂h₂₂−v₀(h₁₃h₂₂+h₁₂h₂₃)+v₀²(h₁₃h₂₃)

m₂₁=(h₁₁²−h₂₁²)−2u₀(h₁₁h₁₃−h₂₁h₂₃)+u₀²(h₁₃²−h₂₃²)

m₂₂=(h₁₂²−h₂₂²)−2v₀(h₁₂h₁₃−h₂₂h₂₃)+v₀²(h₁₃²−h₂₃²)

Formula (15) is linearly solved to obtain fₐ and f_{b}.

After fₐ and f_{b} are solved for, in combination with the predefined principal point (u₀,v₀) and the obliquity factor c, the matrix K of intrinsic parameters may be restored, and then the rotational vector R and the translational vector t may be solved for.

So far, calibration for geometrical and optical parameters of a camcorder (or a camera) is complete.

The parameter calibration method provided in this embodiment can be applied to calibration for a camcorder (or a camera) in a case of a high distortion. In addition, because only one calibration template image is adopted in parameter calibration, compared with an existing camcorder (or a camera) calibration method, this method has advantages, such as being simple and effective, and being easy to operate.

Further, in this embodiment, the parameter calibration method may further include the following steps:

106. Optimize the calculated intrinsic and extrinsic parameters by using a criterion of a minimum re-projection error and by means of the LM (Levenberg-Marquardt, Levenberg-Marquardt) algorithm, so that the intrinsic and extrinsic parameters after optimization become more precise.

Specifically, the following objective function is adopted during optimization:

$$min {\sum }_{j = 1}^{m} {‖ {m}_{j} - m ( K , R , t , {M}_{j} ) ‖}^{2} \qquad ( 16 )$$

In formula (16), mⱼ is a coordinate of a point in the reconstructed distortion correction image, m (K,R,t,Mⱼ) represents a coordinate of a point obtained after a point Mⱼ in the calibration template is perspectively projected onto the calibration template image.

When an iteration error is less than a preset threshold, iteration ends, so that a precise matrix K of intrinsic parameters, rotational vector R, and translational vector t of the camcorder (or the camera) are obtained.

In this embodiment, optimization by means of the LM algorithm makes values of the intrinsic and extrinsic parameters more precise.

A person skilled in the art should learn that the method provided in this embodiment may be applied to parameter calibration for an imaging device, which includes but is not limited to a camcorder, a camera, and the like.

### Embodiment 2

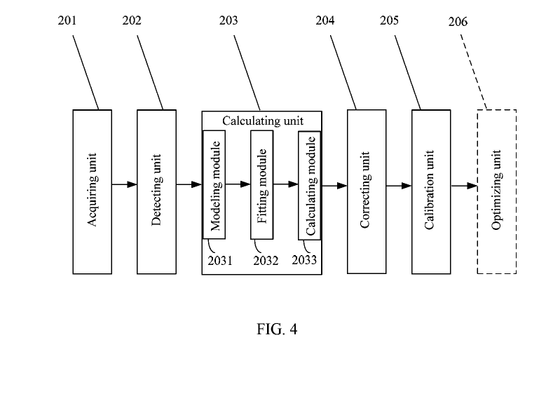

Based on the calibration method described in Embodiment 1, as shown in FIG. 4, Embodiment 2 of the present invention provides a parameter calibration apparatus, where the apparatus includes:

an acquiring unit 201, configured to acquire a calibration template image, where the calibration template image is obtained by photographing a calibration template;

a detecting unit 202, configured to perform corner detection on the calibration template image to extract image corners; and

a calculating unit 203, configured to calculate a radial distortion parameter according to the extracted image corners.

In this embodiment, the calculating unit 203 specifically includes:

a modeling module 2031, configured to, based on a single parameter division model, model a radial distortion according to the following formula, so as to establish a coordinate transformation relationship between the calibration template image and the distortion correction image obtained by correcting the calibration template image:

$${x}_{u} = \frac{{x}_{d}}{1 + λ {r}_{d}^{2}} ,$$

where x_{d}=(x_{d},y_{d}) is a coordinate of any distortion point in the calibration template image, xᵤ=(xᵤ,yᵤ) is a coordinate of a correction point that is in the distortion correction image and obtained after x_{d}=(x_{d},y_{d}) is corrected, λ is a radial distortion parameter, and r_{d}²=x_{d}²+y_{d}²;

a fitting module 2032, configured to, according to a correspondence that a straight line in the calibration template is presented as a circular arc in the calibration template image due to an imaging distortion, perform fitting in combination with the image corners to obtain circular arc parameters of the circular arc, where a straight line equation in the calibration template is axᵤ+byᵤ+c=0, a circular arc equation in the calibration template image is x_{d}²+y_{d}²+Aᵢx_{d}+Bᵢy_{d}+Cᵢ=0, and {Aᵢ,Bᵢ,C_{i|i=}1, 2, 3} are circular arc parameters, where

$${A}_{i} = \frac{a}{c λ} , \\ {B}_{i} = \frac{b}{c λ} , \\ and$$

$${C}_{i} = \frac{1}{λ} ;$$

a calculating module 2033, configured to, according to the circular arc parameters obtained by means of fitting, and according to

(A₁−A₂)x_{d0}+(B₁−B₂)y_{d0}+(C₁−C₂)=0

(A₁−A₃)x_{d0}+(B₁−B₃)y_{d0}+(C₁−C₃)=0

(A₂−A₃)x_{d0}+(B₂−B₃)y_{d0}+(C₂−C₃)=0

solve for a distortion center (x_{d0},y_{d0}) and then calculate the radial distortion parameter in combination with a formula

$$\frac{1}{λ} = {x}_{d 0}^{2} + {y}_{d 0}^{2} + {A}_{i} {x}_{d 0} + {B}_{i} {y}_{d 0} + {C}_{i} ;$$

and

a correcting unit 204, configured to perform radial distortion correction according to the calculated radial distortion parameter, so as to reconstruct a distortion correction image.

In this embodiment, the correcting unit 204 is specifically configured to:

according to the radial distortion parameter and according to an inverse process that the calibration template image is derived from the distortion correction image, solve for a coordinate of a distortion point (x_{di},y_{di}) in the calibration template image corresponding to a correction point (xᵤᵢ,yᵤᵢ) in the distortion correction image, where a subscript i is a number; and

perform bilinear interpolation on the solved coordinate, of the distortion point (x_{di},y_{di}) in the calibration template image, so as to obtain a coordinate of a correction point (xᵤᵢ′,yᵤᵢ′) in the reconstructed distortion correction image.

A calibration unit 205 is configured to, according to a perspective projection relationship between the calibration template and the reconstructed distortion correction image, calculate intrinsic and extrinsic parameters to implement parameter calibration, where the intrinsic and extrinsic parameters include: a matrix of intrinsic parameters, a rotational vector, and a translational vector.

In this embodiment, the calibration unit 205 is specifically configured to:

according to the perspective projection relationship between the calibration template and the reconstructed distortion correction image, estimate a homography matrix H according to the following formula:

s\tilde{x}ᵤ=H\tilde{M}

where s is a scale factor, \tilde{M} is a homogeneous coordinate of a point in the calibration template, \tilde{x}ᵤ is a homogeneous coordinate of a corresponding point obtained after \tilde{M} is projected onto the reconstructed distortion correction image, H=K[r₁ r₂ t],

$$k = [ \begin{matrix}{f}_{a} & c & {u}_{0} \\ 0 & {f}_{b} & {v}_{0} \\ 0 & 0 & 1\end{matrix} ]$$

is a matrix of intrinsic parameters, r₁ and r₂ are rotational vectors and r₁ and r₂ are orthogonal, t is a translational vector, (u₀,v₀) is a principal point of the matrix of intrinsic parameters, c is an obliquity factor, and (fₐ,f_{b}) is an ideal focal length;

according to orthogonality of r₁ and r₂ obtain a constraint condition

$$\{ \begin{matrix}{h}_{1}^{T} {K}^{- T} {K}^{- 1} {h}_{2} = 0 \\ {h}_{1}^{T} {K}^{- T} {K}^{- 1} {h}_{1} = {h}_{2}^{T} {K}^{- T} {K}^{- 1} {h}_{2}\end{matrix} ;$$

preset that an initial value of the principal point (u₀,v₀) coincides with the distortion center (x_{d0},y_{d0}), set the obliquity factor c=0, and

obtain the ideal focal length (fₐ,f_{b}) by performing linear solving in combination with formulas

$${K}^{- T} {K}^{- 1} = [ \begin{matrix}\frac{1}{{f}_{a}^{2}} & 0 & - \frac{{u}_{0}}{{f}_{a}^{2}} \\ 0 & \frac{1}{{f}_{b}^{2}} & - \frac{{v}_{0}}{{f}_{b}^{2}} \\ - \frac{{u}_{0}}{{f}_{a}^{2}} & - \frac{{v}_{0}}{{f}_{b}^{2}} & \frac{{u}_{0}^{2}}{{f}_{a}^{2}} + \frac{{v}_{0}^{2}}{{f}_{b}^{2}} + 1\end{matrix} ]$$

and

$$\{ \begin{matrix}{h}_{1}^{T} {K}^{- T} {K}^{- 1} {h}_{2} = 0 \\ {h}_{1}^{T} {K}^{- T} {K}^{- 1} {h}_{1} = {h}_{2}^{T} {K}^{- T} {K}^{- 1} {h}_{2}\end{matrix} ;$$

and

restore the matrix of intrinsic parameters and then solve for the rotational vector and the translational vector in combination with the preset principal point (u₀,v₀) and the preset obliquity factor c.

The parameter calibration apparatus provided in this embodiment can be applied to calibration for a camcorder (or a camera) in a case of a high distortion; and compared with that in the prior art, the apparatus is simpler to operate because only one calibration template image is adopted in parameter calibration.

Further, in this embodiment, the apparatus further includes:

an optimizing unit 206, configured to optimize the calculated intrinsic and extrinsic parameters by using a criterion of a minimum re-projection error and by means of the Levenberg-Marquardt algorithm.

In this embodiment, after the calculated intrinsic and extrinsic parameters are optimized by means of the LM algorithm, values of the intrinsic and extrinsic parameters are more precise.

It should be noted that this embodiment is specific physical implementation of Embodiment 1 described above, features of this embodiment and Embodiment 1 can be cross-referenced. A person skilled in the art should learn that the apparatus provided in this embodiment may be applied to parameter calibration for an imaging device, which includes but is not limited to a camcorder, a camera, and the like.

A person of ordinary skill in the art may understand that all or a part of the processes of the methods in the embodiments may be implemented by a computer program instructing relevant hardware. The program may be stored in a computer readable storage medium. When the program runs, the processes of the methods in the embodiments are performed. The storage medium may include: a magnetic disk, an optical disc, a read-only memory (Read-Only Memory, ROM), or a random access memory (Random Access Memory, RAM).

The disclosed are merely exemplary embodiments of the present invention, but are not intended to limit the scope of the present invention. Equivalent variation figured out according to the claims shall fall within the protection scope of the present invention.

What is claimed is:

1. A parameter calibration method, comprising:
acquiring a calibration template image, wherein the calibration template image is obtained by photographing a calibration template;
performing corner detection on the calibration template image to extract image corners;
calculating a radial distortion parameter according to the extracted image corners;
performing radial distortion correction according to the calculated radial distortion parameter, so as to reconstruct a distortion correction image; and
according to a perspective projection relationship between the calibration template and the reconstructed distortion correction image, calculating intrinsic and extrinsic parameters to implement parameter calibration, wherein the intrinsic and extrinsic parameters comprise: a matrix of intrinsic parameters, a rotational vector, and a translational vector.

2. The method according to claim 1, wherein the step of calculating a radial distortion parameter according to the extracted image corners comprises:
based on a single parameter division model, modeling a radial distortion according to the following formula, so as to establish a coordinate transformation relationship between the calibration template image and the distortion correction image obtained by correcting the calibration template image:
$${x}_{u} = \frac{{x}_{d}}{1 + λ {r}_{d}^{2}} ,$$
wherein x_{d}=(x_{d},y_{d}) is a coordinate of any distortion point in the calibration template image, xᵤ=(xᵤ,yᵤ) is a coordinate of a correction point that in the distortion correction image and obtained after x_{d}=(x_{d},y_{d}) is corrected, λ is a radial distortion parameter, and r_{d}²=x_{d}²+y_{d}²;
according to a correspondence that a straight line in the calibration template is presented as a circular arc in the calibration template image due to an imaging distortion, performing fitting in combination with the image corners to obtain circular arc parameters of the circular arc, wherein a straight line equation in the calibration template is axᵤ+byᵤ+c=0, a circular arc equation in the calibration template image is x_{d}²+y_{d}²+Aᵢx_{d}+Bᵢy_{d}+Cᵢ=0, and {Aᵢ,Bᵢ,Cᵢ|i=1, 2, 3} are circular arc parameters, wherein
$${A}_{i} = \frac{a}{c λ} , {B}_{i} = \frac{b}{c λ} , and {C}_{i} = \frac{1}{λ} ;$$
and
according to the circular arc parameters obtained by means of fitting and according to:
(A₁−A₂)x_{d0}+(B₁−B₂)y_{d0}+(C₁−C₂)=0
(A₁−A₃)x_{d0}+(B₁−B₃)y_{d0}+(C₁−C₃)=0
(A₂−A₃)x_{d0}+(B₂−B₃)y_{d0}+(C₂−C₃)=0
solving for a distortion center (x_{d0},y_{d0}) and calculating the radial distortion parameter in combination with a formula
$$\frac{1}{λ} = {x}_{d 0}^{2} + {y}_{d 0}^{2} + {A}_{i} {x}_{d 0} + {B}_{i} {y}_{d 0} + {C}_{i} .$$

3. The method according to claim 1, wherein the step of performing radial distortion correction according to the calculated radial distortion parameter, so as to reconstruct a distortion correction image comprises:
according to the radial distortion parameter and according to an inverse process that the calibration template image is derived from the distortion correction image, solving for a coordinate of a distortion point (x_{di},y_{di}) that is in the calibration template image and corresponding to a correction point (xᵤᵢ,yᵤᵢ) in the distortion correction image; and
performing bilinear interpolation on the solved coordinate of the distortion point (x_{di},y_{di}) in the calibration template image, so as to obtain a coordinate of a correction point (xᵤᵢ′,yᵤᵢ′) in the reconstructed distortion correction image.

4. The method according to claim 3, wherein the step of calculating intrinsic and extrinsic parameters according to a perspective projection relationship between the calibration template and the reconstructed distortion correction image comprises:
according to the perspective projection relationship between the calibration template and the reconstructed distortion correction image, estimating a homography matrix H according to the following formula:
s\tilde{x}ᵤ=H\tilde{M}
wherein s is a scale factor, \tilde{M} is a homogeneous coordinate of a point in the calibration template, \tilde{x}ᵤ is a homogeneous coordinate of a corresponding point obtained after \tilde{M} is projected onto the reconstructed distortion correction image, H=K[r₁ r₂ t],
$$K = [ \begin{matrix}{f}_{a} & c & {u}_{0} \\ 0 & {f}_{b} & {v}_{0} \\ 0 & 0 & 1\end{matrix} ]$$
is a matrix of intrinsic parameters, r₁ and r₂ are rotational vectors and r₁ and r₂ are orthogonal, t is a translational vector, (u₀,v₀) is a principal point of the matrix of intrinsic parameters, c is an obliquity factor, and (fₐ,f_{b}) is an ideal focal length;
according to orthogonality of r₁ and r₂ obtaining a constraint condition
$$\{ \begin{matrix}{h}_{1}^{T} {K}^{- T} {K}^{- 1} {h}_{2} = 0 \\ {h}_{1}^{T} {K}^{- T} {K}^{- 1} {h}_{1} = {h}_{2}^{T} {K}^{- T} {K}^{- 1} {h}_{2}\end{matrix} ;$$
presetting that an initial value of the principal point (u₀,v₀) coincides with the distortion center (x_{d0},y_{d0}), presetting the obliquity factor c=0, and
obtaining the ideal focal length (fₐ,f_{b}) by performing linear solving in combination with formulas
$${K}^{- T} {K}^{- 1} = [ \begin{matrix}\frac{1}{{f}_{a}^{2}} & 0 & - \frac{{u}_{0}}{{f}_{a}^{2}} \\ 0 & \frac{1}{{f}_{b}^{2}} & - \frac{{v}_{0}}{{f}_{b}^{2}} \\ - \frac{{u}_{0}}{{f}_{a}^{2}} & - \frac{{v}_{0}}{{f}_{b}^{2}} & \frac{{u}_{0}^{2}}{{f}_{a}^{2}} + \frac{{v}_{0}^{2}}{{f}_{b}^{2}} + 1\end{matrix} ]$$
and
$$\{ \begin{matrix}{h}_{1}^{T} {K}^{- T} {K}^{- 1} {h}_{2} = 0 \\ {h}_{1}^{T} {K}^{- T} {K}^{- 1} {h}_{1} = {h}_{2}^{T} {K}^{- T} {K}^{- 1} {h}_{2}\end{matrix} ;$$
and
restoring the matrix of intrinsic parameters and then solving for the rotational vector and the translational vector in combination with the preset principal point (u₀,v₀) and the preset obliquity factor c.

5. The method according to claim 1, further comprising:
optimizing the calculated intrinsic and extrinsic parameters by using a criterion of a minimum re-projection error and by means of the Levenberg-Marquardt algorithm.

6. The method according to claim 1, wherein the calibration template is a calibration template with an array of fixed spacing patterns.

7. A parameter calibration apparatus, comprising:
an acquiring unit, configured to acquire a calibration template image, wherein the calibration template image is obtained by photographing a calibration template;
a detecting unit, configured to perform corner detection on the calibration template image to extract image corners;
a calculating unit, configured to calculate a radial distortion parameter according to the extracted image corners;
a correcting unit, configured to perform radial distortion correction according to the calculated radial distortion parameter, so as to reconstruct a distortion correction image; and
a calibration unit, configured to, according to a perspective projection relationship between the calibration template and the reconstructed distortion correction image, calculate intrinsic and extrinsic parameters to implement parameter calibration, wherein the intrinsic and extrinsic parameters comprise: a matrix of intrinsic parameters, a rotational vector, and a translational vector.

8. The apparatus according to claim 7, wherein the calculating unit specifically comprises:
a modeling module, configured to, based on a single parameter division model, model a radial distortion according to the following formula, so as to establish a coordinate transformation relationship between the calibration template image and the distortion correction image obtained by correcting the calibration template image:
$${x}_{u} = \frac{{x}_{d}}{1 + λ {r}_{d}^{2}} ,$$
wherein x_{d}=(x_{d},y_{d}) is a coordinate of any distortion point in the calibration template image, xᵤ=(xᵤ,yᵤ) is a coordinate of a correction point that is in the distortion correction image and obtained after x_{d}=(x_{d},y_{d}) is corrected, λ is a radial distortion parameter, and r_{d}²=x_{d}²+y_{d}²;
a fitting module, configured to, according to a correspondence that a straight line in the calibration template is presented as a circular arc in the calibration template image due to an imaging distortion, perform fitting in combination with the image corners to obtain circular arc parameters of the circular arc, wherein a straight line equation in the calibration template is axᵤ+byᵤ+c=0, a circular arc equation in the calibration template image is x_{d}²+y_{d}²+Aᵢx_{d}+Bᵢy_{d}+Cᵢ=0, and {Aᵢ,Bᵢ,Cᵢ|i=1, 2, 3} are circular arc parameters, wherein
$${A}_{i} = \frac{a}{c λ} , {B}_{i} = \frac{b}{c λ} , and {C}_{i} = \frac{1}{λ} ;$$
and
a calculating module, configured to, according to the circular arc parameters obtained by means of fitting and according to
(A₁−A₂)x_{d0}+(B₁−B₂)y_{d0}+(C₁−C₂)=0
(A₁−A₃)x_{d0}+(B₁−B₃)y_{d0}+(C₁−C₃)=0,
(A₂−A₃)x_{d0}+(B₂−B₃)y_{d0}+(C₂−C₃)=0
solve for a distortion center (x_{d0},y_{d0}) and then calculate the radial distortion parameter in combination with a formula
$$\frac{1}{λ} = {x}_{d 0}^{2} + {y}_{d 0}^{2} + {A}_{i} {x}_{d 0} + {B}_{i} {y}_{d 0} + {C}_{i} .$$

9. The apparatus according to claim 7, wherein the correcting unit is specifically configured to:
according to the radial distortion parameter and according to an inverse process that the calibration template image is derived from the distortion correction image, solve for a coordinate of a distortion point (x_{di},y_{di}) that is in the calibration template image and corresponding to a correction point (xᵤᵢ,yᵤᵢ) in the distortion correction image; and
perform bilinear interpolation on the solved coordinate of the distortion point (x_{di},y_{di}) in the calibration template image, so as to obtain a coordinate of a correction point (xᵤᵢ′,yᵤᵢ′) in the reconstructed distortion correction image.

10. The apparatus according to claim 9, wherein the calibration unit is specifically configured to:
according to the perspective projection relationship between the calibration template and the reconstructed distortion correction image, estimate a homography matrix H according to the following formula:
s\tilde{x}ᵤ=H\tilde{M}
wherein s is a scale factor, \tilde{M} is a homogeneous coordinate of a point in the calibration template, \tilde{x}ᵤ is a homogeneous coordinate of a corresponding point obtained after \tilde{M} is projected onto the reconstructed distortion correction image, H=K[r₁ r₂ t],
$$K = [ \begin{matrix}{f}_{a} & c & {u}_{0} \\ 0 & {f}_{b} & {v}_{0} \\ 0 & 0 & 1\end{matrix} ]$$
is a matrix of intrinsic parameters, r₁ and r₂ are rotational vectors and r₁ and r₂ are orthogonal, t is a translational vector, (u₀,v₀) is a principal point of the matrix of intrinsic parameters, c is an obliquity factor, and (fₐ,f_{b}) is an ideal focal length;
according to orthogonality of r₁ and r₂, obtain a constraint condition
$$\{ \begin{matrix}{h}_{1}^{T} {K}^{- T} {K}^{- 1} {h}_{2} = 0 \\ {h}_{1}^{T} {K}^{- T} {K}^{- 1} {h}_{1} = {h}_{2}^{T} {K}^{- T} {K}^{- 1} {h}_{2}\end{matrix} ;$$
preset that an initial value of the principal point (u₀,v₀) coincides with the distortion center (x_{d0},y_{d0}), set the obliquity factor c=0, and
obtain the ideal focal length (fₐ,f_{b}) by performing linear solving in combination with formulas
$${K}^{- T} {K}^{- 1} = [ \begin{matrix}\frac{1}{{f}_{a}^{2}} & 0 & - \frac{{u}_{0}}{{f}_{a}^{2}} \\ 0 & \frac{1}{{f}_{b}^{2}} & - \frac{{v}_{0}}{{f}_{b}^{2}} \\ - \frac{{u}_{0}}{{f}_{a}^{2}} & - \frac{{v}_{0}}{{f}_{b}^{2}} & \frac{{u}_{0}^{2}}{{f}_{a}^{2}} + \frac{{v}_{0}^{2}}{{f}_{b}^{2}} + 1\end{matrix} ]$$
and
$$\{ \begin{matrix}{h}_{1}^{T} {K}^{- T} {K}^{- 1} {h}_{2} = 0 \\ {h}_{1}^{T} {K}^{- T} {K}^{- 1} {h}_{1} = {h}_{2}^{T} {K}^{- T} {K}^{- 1} {h}_{2}\end{matrix} ;$$
and
restore the matrix of intrinsic parameters and then solve for the rotational vector and the translational vector in combination with the preset principal point (u₀,v₀) and the preset obliquity factor c.

11. The apparatus according to claim 7, further comprising:
an optimizing unit, configured to optimize the calculated intrinsic and extrinsic parameters by using a criterion of a minimum re-projection error and by means of the Levenberg-Marquardt algorithm.
